(19) United States
(12) Patent Application Publication
(10) Pub. No.: US 2014/0282154 A1
(43) Pub. Date: Sep. 18, 2014

(54) METHOD FOR PROCESSING A COMPOUND GESTURE, AND ASSOCIATED DEVICE AND USER TERMINAL

(71) Applicant: ORANGE, PARIS (FR)

(72) Inventors: Eric Petit, St. Martin D'Heres (FR); Stephane Coutant, Corenc (FR)

(73) Assignee: ORANGE, PARIS (FR)

(21) Appl. No.: 14/215,869

(22) Filed: Mar. 17, 2014

(30) Foreign Application Priority Data
Mar. 15, 2013 (FR) 13 52310

(51) Int. Cl. G06F 3/0484; G06F 3/0482; G06F 3/0488; G06F 3/0481

(52) U.S. Cl. CPC G06F 3/04842; G06F 3/04817; G06F 3/0482; G06F 3/0488
USPC 715/765

(57) ABSTRACT

A method for processing a compound gesture, made by a user using a pointing tool on a sensitive pad of a terminal. The terminal has a screen for reproducing a graphical representation of a sequence of selectable graphical elements and a module for processing and interpreting an interaction with the sensitive pad according to a mode selected from a default, relative-positioning mode of sequential interaction and an absolute-positioning mode of graphical interaction. During execution of the gesture by the user, on detection of static pointing to a spatial position on the sensitive pad during a predetermined period of time, the module toggles to the absolute-positioning mode of graphical interaction. When the pointing position is situated a distance below a threshold from a graphical element displayed on the screen, the module selects the graphical element, without the pointing tool being raised, then toggles to the relative-positioning mode of sequential interaction.

### 1. FIELD OF THE INVENTION

The field of the invention is that of interactions, more precisely of sensitive interactions between a user and a terminal.

The present invention relates to a method for processing a compound gesture, executed by a user on a sensitive pad using a pointing tool.

It likewise relates to a processing device that is capable of implementing such a method. It also relates to a user terminal comprising such a device.

The invention applies particularly advantageously to sensitive interfaces that are intended for partially sighted users or users in an “eyes-free”-type use situation.

### 2. PRESENTATION OF THE PRIOR ART

Sensitive interfaces, for example touch interfaces on terminals today, a tablet or what is known in English as a “smartphone”, are largely reliant on conventional graphical interfaces (Graphical User Interface, GUI in English), the interaction model for which is based on pointing to objects using a pointing tool, stylus or finger. Said interaction model is inherited from the model called WIMP (“Windows Icons Menus Pointer” in English), according to which each interface element has a precise spatial position in an identifier on the screen of the terminal of the user that the user needs to know in order to be able to manipulate it. This interaction model, based on absolute positioning, is used by sighted persons in order to interact with applications on their terminal.

When applied to touch manipulation of scrolling lists of selectable graphical elements, this interaction model, although very popular, nevertheless has limits in terms of use. The gesture is generally broken down into two phases that are coupled to one another; selection (“focus” in English), in the course of which a graphical element is temporarily highlighted, while the finger remains in contact with the sensitive pad, and validation of the selection, by raising the finger or applying pressure of “tap” or “touch” type, in English. In particular, the validation of a selected graphical element in the list requires a high level of precision for the gesture, without the simple possibility for the user to correct his gesture in the event of a pointing error. This is because if the selected graphical element is not the correct one then the user only has the possibility of sliding his finger over the surface, which cancels the preceding selection, and of recommencing his pointing gesture. If, finally, his selection is correct, the user needs to validate it by raising his finger, but without sliding it, even very slightly, failing which he loses his selection and also has to recommence his gesture from the beginning.

This graphical interaction model based on absolute positioning is also used by visually handicapped persons but in what is known as an “exploratory” mode of interaction, according to which the target graphical element is first of all located by trial and error using a voice synthesis module, and then activated, for example by means of a rapid double tap. This exploratory mode conventionally allows—as in the “Talkback” system from Google, registered trademark, for example—highlighting or preselection of a graphical element to be moved from one interface to the other on the trajectory of the finger. The result of this is that only the elements displayed by the interface can be reached, which requires the use of another mechanism in order to be able to move the visible window. Added to this first drawback is a second linked to the fact that the precision of the gesture is dependent on the size and arrangement of the elements displayed in the visible window.

To overcome these difficulties, some systems such as “Talkback” (from Android version 4.1), propose, in addition to the exploratory mode, a second mode of interaction/navigation called sequential or linear, based on the step-by-step movement of a preselection. A simple and rapid gesture in a given direction moves the preselection of the current graphical element to the next element on a defined navigation path. It will be noted that, in order to execute this gesture, the starting position of the finger or of the pointing tool is of little importance, since only the direction and the speed of execution are taken into account.

Thus, contrary to the exploratory mode that is linked to absolute positioning, this sequential mode is based on relative positioning. However, in this latter system, the two modes of interaction, exploratory and sequential, do not coexist very well. The first problem stems from the fact that there is a risk of the user who starts his selection task with the sequential mode involuntarily toggling to the exploratory mode, thus causing an untimely change of focus, which suddenly jumps to one of the elements of the interface instead of following the defined route. This happens when the gesture is not sufficiently rapid on starting. The second problem stems from the fact that it is not possible to combine these two modes within one and the same gesture, by changing from an absolute-positioning mode to a relative-positioning mode. The reason is that if the user has first of all used absolute pointing for approximate positioning of the focus, he cannot, without raising his finger, toggle to the sequential mode in order to adjust his position. To use the sequential mode, he inevitably has to interrupt his gesture, which ruins the flow and coherence of the interaction.

Finally, since the sequential mode is generally based on a speed criterion, a third drawback stems from the fact that it also does not allow several elements to be scrolled at once. The reason is that, in order to accomplish this, it would thus be necessary to take into account the distance covered by the finger. This would suppose that the gesture is able to start slowly in order to be able to control the scrolling of the focus on the graphical elements. Now if the gesture starts slowly, it is the exploratory mode of interaction that prevails over the sequential mode.

In conclusion, today there are firstly interfaces dedicated to sighted persons, who are able to bring their visual attention to the graphical interface of their terminal and have good gestural ability, and secondly interfaces dedicated to partially sighted persons, but which do not offer a coherent mode of interaction, since they require a succession of gestures that are interpreted according to distinct modes of interaction, a source of error and confusion for the user.

### 3. SUMMARY OF THE INVENTION

An aspect fo the present disclosure relates to a method for processing a compound gesture, made by a user using a pointing tool on a sensitive pad for a piece of terminal equipment, said equipment moreover having a screen that is capable of reproducing a graphical representation of at least part of an ordered sequence of selectable graphical elements and a module for processing an interaction with the sensitive pad that is capable of interpreting said interaction according to a mode of interaction belonging to a group comprising at least one relative-positioning mode of sequential interaction and an absolute-positioning mode of graphical interaction.

Such a method comprises the following steps, implemented during the execution of the gesture by the user, the default mode of interaction used being the relative-positioning mode of sequential interaction:
on detection of static pointing to a spatial position on the sensitive pad during a predetermined period of time, toggling to the absolute-positioning mode of graphical interaction;
when said pointing position is situated at a distance below a predetermined threshold from a graphical element displayed on the screen, selection of said graphical element;
then toggling to the relative-position mode of sequential interaction, without the pointing tool being raised.

With the invention, the default mode of interaction is the relative-positioning mode of sequential interaction and the absolute-positioning mode of graphical interaction is activated only by a specific action that is predetermined by the user.

The invention is based on a totally novel and inventive approach to processing gestural interactions, according to which the relative-positioning mode of sequential interaction is always accessible even after changing to the absolute positioning mode, this being in the course of a single continuous gesture in which the finger remains in contact with the touchpad. The toggling to the absolute-positioning mode of graphical interaction is triggered by prolonged static pointing (without the need for physical contact) to a point on the sensitive pad. The user therefore has the possibility of choosing the moment at which he triggers this absolute-positioning mode of graphical interaction, for example on the basis of the visual access to the screen that he has. This mode allows him particularly to select a graphical element displayed on the screen by simply pointing close to a graphical element and without having to raise the pointing tool. The selected graphical element is highlighted, for example by means of a frame or highlighting. Once this selection step has finished, the relative-positioning mode of sequential interaction is automatically reactivated.

Contrary to the prior art, the user no longer needs to raise the pointing tool in order to signify that he wishes to change mode of interaction. The user can therefore change from one mode to the other without interrupting his gesture and without great constraint on the execution of this gesture. The reason is that, in the relative mode, trembling of the finger or of the pointing tool does not cause the selection to be lost, because the tolerance with respect to the position of the gesture can be regulated independently of the spatial arrangement of the elements. On the contrary, if the user raises the pointing tool, the selection is nevertheless preserved. He can therefore take the time that he wishes in order to continue the compound gesture that he has initiated.

A case of use that is of particular interest in this invention is that of the correction of first imprecise pointing. A user who approximately knows the spatial location of a graphical element in a sequence from a graphical interface points his pointing tool around this location in order to select this graphical element and then to activate it. According to the invention, the prolonged pointing that he carries out triggers the toggling to the absolute-positioning mode of interaction and, by way of example, according to the precision of the pointing, the selection of a graphical element next to the one that he was aiming for at the beginning. Without it being necessary for the user to raise his pointing tool, this selection triggers the automatic reactivation of the relative-positioning sequential mode. The gesture initiated is therefore not considered to have finished. With the invention, the user has—in contrast to the prior art—the possibility of continuing his gesture in the sequential mode. In order to adjust his selection, he can then sequentially cover the sequence of elements until he reaches the element of interest. He therefore does not need to be precise in his initial pointing, nor to pay close visual attention to the spatial arrangement of the graphical elements displayed on the screen. With the invention, the correction of an imprecise gesture is made easier in comparison with the two modes of interaction.

The invention thus allows the problem of inconsistency between the modes of interaction with a sensitive pad from the prior art to be solved by proposing a solution that combines them in a simple and intuitive manner for the user.

According to one aspect of the invention, the method for processing a compound gesture moreover comprises the following step:
on detection of movement of the pointing tool in a first predetermined orientation, adjustment of the selection to a subsequent or preceding graphical element, in a first direction, in said ordered sequence, the number of graphical elements covered in the sequence being proportional to the movement of the pointing tool on the sensitive pad and independent of the spatial arrangements of the graphical elements.

In the relative-positioning mode of sequential interaction that in this case is the default mode, the only constraint that the user then needs to satisfy in order to adjust his selection is to provide his gesture with a trajectory in a predetermined orientation, for example vertical, a predetermined direction, for example downward, and an amplitude based on the progress that he desires in the ordered sequence of selectable graphical elements. No speed constraint is associated with this linear gesture.

It will be noted that the opposite direction allows the user to move back or return to the back in the ordered sequence.

Thus, contrary to the prior art solutions implementing the sequential mode, when the user makes a linear gesture, he is free to execute it at the speed that he desires. The invention is therefore well suited to users who have handicaps.

This means that the user is able, in order to increase the amplitude of his gesture and to cover a larger number of graphical elements (than those displayed on the screen), to repeat the same gesture portion several times in the predetermined direction, at the speed that he desires, by starting his gesture from where he desires, by raising his finger from the sensitive pad between two portions, without even so triggering the change to the validation step or the end of the processing.

According to another aspect of the invention, the method moreover comprises the following step:
on detection of movement of the pointing tool along a predetermined second axis and second direction, validation of the selection, comprising the triggering of a validation command associated with the last selected graphical element.

In order to validate his selection, the user no longer needs to interrupt his gesture, for example by raising his finger. He simply needs to make a linear gesture in a predetermined second orientation and second direction, for example horizontally and to the right. Advantageously, a sensitivity for the triggering of the validation can be regulated on the basis of a minimum threshold of distance covered by the pointing tool in order to adapt to the precision of the user and to avoid false validations.

According to this aspect of the invention, the user is thus able to make a compound gesture that is analyzed on a phase-by-phase basis by detecting at least three distinct gesture phases: a selection phase, in the course of which the user selects a selectable graphical element displayed on the screen by means of static pointing of sufficient duration on the sensitive pad, an adjustment phase in the course of which the selection is moved on the basis of the linear movement of the pointing tool along a predetermined axis and direction, and a validation phase, in the course of which the possibly adjusted selection is validated by means of a linear gesture along a predetermined second axis and second direction.

Since the absolution positioning of the pointing tool on an element displayed on the screen of the terminal is implemented only upon initialization of the gesture, with an adjustment to follow, by means of simple sliding of the pointing tool along a given axis and direction, the user has, during the execution of a compound gesture, only very little need for precision either in his manipulation or in the visual monitoring that he performs on the screen.

With the invention, the tolerance to involuntary sliding of the pointing tool is greater on account of the automatic toggling to relative-positioning sequential mode once the selection has been made.

Moreover, during the adjustment step that follows the selection, the user retains control over the selection, with sensitivity over the distance covered being able to be regulated independently of the spatial arrangement of the elements.

The invention therefore allows the visual motor constraint to which the user is usually subject to be relaxed. It is therefore suited both to sighted users and to partially sighted users or users in an “eyes-free” situation.

This relaxing of the visual motor coordination constraint presents a great benefit, in terms of design and use “for all”. The reason is that it notably allows a glimpse of the design of a main menu system for terminals that is able to be applied to any type of interface (mobile, web, multimedia) and any type of user (expert, beginner, partially sighted person, etc.).

The invention thus proposes a generic solution for interpreting a gesture, based on a relative-positioning mode of interaction and allowing easy toggling to the absolute-positioning mode of interaction, and vice versa.

This generic interaction technique can be integrated into a touch interface component of hierarchic menu type allowing the organization, presentation and selection/activation of the functions/data of any application.

According to one aspect of the invention, prior to the selection step, a selectable graphical element displayed on the screen is preselected.

Before the selection step is implemented, a preselection is placed onto a graphical element that can be selected by default. By way of example, this preselection is shown by a visual indicator placed on the preselected graphical element. An advantage of this solution is that it is simple and that it allows the user to very rapidly identify where the cursor is located before commencing his gesture.

According to another aspect of the invention, the method for processing a compound gesture moreover comprises a step of modifying the graphical representation reproduced on the screen at least on the basis of the adjustment of the selection.

The graphical representation reproduced on the screen automatically adapts itself to the movement induced by the gesture of the user in the ordered sequence of selectable graphical elements, so that the selected graphical element is always visible and that the user is able to reach all the selectable elements of the interface. Thus, what is displayed on the screen remains consistent with the adjustment of the preselection.

According to another aspect of the invention, the validation command belongs to a group comprising at least:
the access to a lower level of a hierarchic menu of selectable graphical elements;
the launch of a determined application program;
the validation of an option;
the return to the higher level of a hierarchic menu of selectable graphical elements.

The selectable graphical elements in the ordered sequence may be of different type: either they are directly associated with a predetermined action, such as the launch of an application or the checking of a box, or they allow access to an ordered subsequence of selectable graphical elements when the sequence is organized hierarchically. An advantage of the method according to the invention is that it allows a compound gesture to be processed.

According to yet another aspect of the invention, following the validation of the selection, said validation comprising the triggering of a command for accessing a hierarchic submenu of graphical elements, said method is capable of repeating at least one of the steps of selection, adjustment and validation, on the basis of the detected interaction.

An advantage of the invention is that it allows the processing of the compound gestures linking together a succession of single gestures and prolonged static pointing in order to select an element, which are linear in a first orientation and a first direction for the adjustment of a selected element and/or which are linear in a second orientation and a second direction for the validation of the selection. The steps of selection, adjustment and validation are consequently successive, on the basis of the interaction detected by the terminal. Since the invention does not require the finger to be raised between each gesture, it is also possible to envisage navigating a hierarchic menu using one and the same compound gesture.

With the invention, this gesture is therefore not interpreted as finished at the conclusion of the validation step. This means that the three phases can be linked together in the same compound gesture continuously, in a freely flowing manner and with little constraint. The reason is that the user has the possibility of producing this linking-together using a plurality of successive single gestures, with or without his pointing tool being raised.

According to yet another aspect, the method for processing a compound gesture moreover comprises a step of emission of a visual, vibratory or audible notification signal when a selection, an adjustment or a validation has been made.

The various steps for processing the compound gesture are announced distinctly, using a clearly recognizable visual, audible or vibratory signal. An advantage of such notification is that it assists the user in executing his gesture.

For a partially sighted user or else a user in an “eyes-free” situation, an audible, audio or vibratory notification will be more suitable than a visual notification.

For a sighted user, a visual notification, possibly accompanied by an audible or vibratory notification, marks out his navigation and allows him to give only a small amount of visual attention to the graphical representation reproduced on the screen.

The type of notification may furthermore be suited to the case of use and to the type of user, in order that even if the latter does not have visual access to the screen, he is able to follow the steps of the processing of his gesture and develop it accordingly.

The processing method that has just been presented in these various embodiments can be implemented by a processing device according to the invention.

Such a device comprises at least one selection unit, which is implemented during the execution of the gesture by the user, said unit comprising the following subunits:
on detection of static pointing to a spatial position on the sensitive pad during a predetermined period of time in one position on the sensitive pad, toggling to the absolute-positioning mode of graphical interaction;
when said tapped position is situated at a distance below a predetermined threshold from a graphical element displayed on the screen, selection of said graphical element,
then toggling to the relative-positioning mode of sequential interaction.

Advantageously, it also comprises a unit for adjusting the selection, a module for validating the selection, a unit for modifying the graphical representation on the basis of the adjustment of the selection, a unit for emitting a visual, vibratory or audible notification signal when a selection, an adjustment or a validation has been made.

The invention also relates to a piece of terminal equipment, comprising a sensitive pad and a reproduction screen that is capable of reproducing a graphical representation of at least part of an ordered sequence of selectable graphical elements, and a device for processing a compound gesture by the user on said pad using a pointing tool according to the invention.

The invention further relates to a computer program having instructions for the implementation of the steps of a method for processing a compound gesture as described previously when said program is executed by a processor. Such a program is able to use any programming language. It can be downloaded from a communication network and/or recorded on a computer-readable medium.

Finally, the invention relates to a storage medium that can be read by a processor, is integrated or not integrated in the processing device according to the invention, is possibly removable and stores a computer program implementing a processing method as described previously.

The recording media mentioned above may be any entity or device that is capable of storing the program and that can be read by a piece of terminal equipment. By way of example, the media may include a storage means, such as a ROM, for example a CD-ROM or a ROM in a microelectronic circuit, or else a magnetic recording means, for example a floppy disk or a hard disk.

On the other hand, the recording media may correspond to a transmissible medium such as an electrical or optical signal, which can be conveyed via an electrical or optical cable, by radio or by other means. The programs according to the invention may be, in particular, downloaded on a network of Internet type.

### 4. LIST OF FIGURES

Other advantages and features of the invention will emerge more clearly on reading the description below of a particular embodiment of the invention, given by way of simple illustrative and nonlimiting example, and the appended drawings, among which:

FIG. 1 schematically shows an example of graphical representation of a set of selectable graphical elements on a screen of a user terminal, according to an embodiment of the invention;

FIG. 2 schematically shows the steps of the method for processing a compound gesture according to a first embodiment of the invention;

FIGS. 3A to 3F schematically show a first example of a compound gesture processed by the processing method according to the invention, applied to a first type of graphical interface;

FIGS. 4A to 4G schematically illustrate a second example of a compound gesture processed by the processing method according to the invention, applied to a second type of graphical interface;

FIGS. 5A to 5G schematically illustrate a third example of a compound gesture processed by the processing method according to the invention, applied to the second type of graphical interface; and

FIG. 6 shows an example of the structure of a device for processing a touch gesture according to an embodiment of the invention.

### 5. DESCRIPTION OF A PARTICULAR EMBODIMENT OF THE INVENTION

In the text below, a single gesture denotes a continuous gesture made in one go without the pointing tool being raised (“stroke” in English). Compound gesture is understood to mean a gesture comprising several distinct phases, a phase being formed by one or more single gestures.

In relation to FIG. 1, a piece of user terminal equipment ET of “smartphone” or tablet type, for example, is shown, comprising a sensitive, for example touch, pad DT superimposed on a screen SC.

It will be noted that the invention is not limited to this illustrative example and can be used even if the graphic screen is off or absent, particularly if it is remote, as in the case of a touch remote control acting remotely on a screen. A graphical representation RG comprising a set of selectable graphical elements EG₁ to EG_{N} (“items” in English) is displayed, at least in part on the screen SC. It should be understood that some elements EG_{M+1} to EG_{N} may not be displayed if the size of the screen is insufficient in relation to that of the graphical representation under consideration. However, these elements are part of the graphical interface and can be selected.

Among the displayed elements, one of the elements EGi has been preselected. To show this, its appearance has been modified. By way of example, it is framed in the figure using a thick colored frame. As a variant, it could be highlighted.

In this example, the selectable graphical elements are icons arranged in a grid. However, the invention is not limited to this particular case of spatial arrangement or of graphical elements, and any other type of graphical representation can be envisaged, in particular a representation in the form of a vertical linear list of text elements is a possible alternative.

The user has a pointing tool or else uses his finger to interact with the touchpad and to select a selectable graphical element of the representation RG. In the text below, reference will be made to a pointing tool to denote one or the other indiscriminately.

The terminal ET comprises a module for processing the touch interactions that is capable of functioning according to at least two modes of interaction:
A first mode, called absolute-positioning mode of graphical interaction, which is triggered by a prolonged static tap in a spatial position on the pad DT, allowing the user to select a graphical element when the tapped position is close to the location of a selectable graphical element EGi that is shown on the screen. According to this mode, the selection is placed onto the selectable graphical element EGj that is closest to the position indicated by the pointing tool, following the prolonged static tap by the user on the touchpad;
A second mode, called relative-positioning mode of sequential interaction, that is implemented by default, which not only allows the user to move the selection from one selectable graphical element to another in a predetermined coverage order, using a linear gesture made in a predetermined first orientation and first direction, with several successive movements being possible in the course of the same gesture. This mode also allows the user to validate a preselection using a linear gesture made in a predetermined second orientation and second direction. This mode does not require great visual motor control from the user.

It will be noted that the invention that will be described below in more detail can be implemented by means of software and/or hardware components. With this in mind, the terms “module” and “entity” used in this document may correspond either to a software component or to a hardware component, or else to a set of hardware and/or software components that are capable of implementing the function(s) described for the module or the entity in question.

With reference to FIG. 2, the steps of the method for processing a compound gesture according to a first embodiment of the invention are now presented.

The user of the terminal equipment ET wishes to select the selectable graphical element EGi of the graphical representation RG. The method for processing a compound gesture according to the invention is implemented on detection of the pointing tool of the user being placed into contact with the touchpad of the terminal ET.

It will be noted that the detection of an interaction comes to an end normally on detection of a loss of contact between the pointing tool and the touchpad DT. Nevertheless, an inertial mechanism can be activated, based on a physical model involving a virtual mass and frictional forces, so that the processing can be continued over a certain virtual distance in the extension of the gesture after the loss of contact.

In the course of a first step T0, the selectable graphical element EG₁ is selected. This is an initial selection that serves as a starting point upon implementation of the method for processing a compound gesture according to an aspect of the invention.

According to a first aspect, the initial selection corresponds to an existing preselection from previous manipulation of the interface, or else to a selectable element defined by default. This element preselected by default or otherwise may be any, for example the first element displayed at the top and to the left of the screen.

According to a second aspect of the invention, the gesture by the user commences by means of static pointing, with or without pressure, of short duration, for example 500 ms, close to a selectable graphical element that is displayed on the screen. On detection of this static pointing, the processing method according to the invention triggers the toggling of the relative-positioning mode of sequential interaction MS to the absolute-positioning mode of graphical interaction MG at T_{1,0}, then the selection of the closest graphical element at T_{1,1}. This element selected at the start of the gesture, EGi, is the one for which the spatial coordinates in a benchmark of the screen are closest to those of the initial position of the gesture of the user. It is understood that this static pointing of short duration is what allows triggering of the interpretation of this gesture phase according to an absolute-positioning mode of interaction. Once the selection has been initialized, the toggling T_{1,2} to the relative-positioning mode MS of sequential interaction takes place automatically.

In the course of a step T2, linear movement of the pointing tool between the starting point and an arrival point, in a first orientation and a first direction, is measured. By way of example, this gesture is made in a vertical orientation and a downward direction.

It is therefore interpreted according to a relative-positioning mode of interaction, that is to say solely on the basis of relative X and Y movements in a spatial benchmark of the touchpad and independently of the spatial arrangement of the elements displayed on the screen. As a sufficient relative movement, that is to say one above a certain threshold SD, is measured in the predetermined orientation ori, the selection is moved to the next element in the ordered sequence. On each new movement in the fixed direction dir above the threshold SD, a new element is selected. At the end of this step, the selection has therefore been adjusted from the initially selected graphical element EGi to another selectable graphical element in the sequence.

It is possible to predict the total number k of elements overflown on the basis of the distance d covered, which corresponds to the sum of the relative movements accumulated along the predetermined axis and direction, by means of the following law:

k=α·d (1)

where

$$α = \frac{1}{SD}$$

is a sensitivity parameter. The greater its value, the greater the number of selectable graphical elements overflown, at a constant distance covered.

Thus, if the value of the threshold SD is fixed at a low value, the sensitivity a will be high as well as the number of elements k covered in the course of the successive gesture(s) from the adjustment phase.

The sensitivity of the gestural navigation may be suited on the basis of the preferences of the user, which is an additional advantage of the relative-positioning mode of interaction.

According to one variant, the sensitivity of the scrolling can be modulated on the basis of the dynamics of the gesture. On account of this, the law is written as follows:

k=α(t)·d(t), where t is a temporal variable.

Thus, when starting a gesture, the variation in the speed of the point of contact of the pointing tool increases, so the sensitivity is artificially increased, this in order to increase the effectiveness or efficiency of the manipulation of the sequence of graphical elements. Conversely, when the speed decreases, particularly at the end of a gesture at the moment of the final selection, so the sensitivity is artificially decreased, so as to increase the precision of the gesture during the adjustment phase. This is all the more advantageous in the case of a compound gesture leading to validation of the last selected graphical element.

In the course of a step T3, a linear gesture in a second orientation and a second direction is detected robustly using a technique similar to that that has just been presented. It is interpreted as validation of the previous selection.

Advantageously, a sensitivity may be associated with the interpretation of this gesture, in a similar manner to that used in step T2, with a different value. One advantage is avoiding false validations and adapting to the considered precision of the user, said precision being able to vary.

This step results in the triggering of at least one validation command that is associated with the last graphical element selected or associated with the hierarchic level of the element in question, for example in the case of a “return to the previous menu” command.

A first example of a compound gesture G1 processed by the method according to this embodiment of the invention will now be presented with reference to FIGS. 3A to 3F. The whole compound gesture is illustrated by FIG. 3F.

In this example, it is assumed that the selectable graphical elements EG₁ to EG_{N} of the set under consideration are shown in a grid and that they are organized sequentially, according to a predetermined coverage order, for example in a Z as indicated in FIGS. 1 and 3C. With reference to FIG. 3A, the first displayed graphical element EG1 has been preselected. In this example, it is visually highlighted using a thick frame FOC. The gesture that will now be described is broken down here into three single phases or gestures, which are respectively processed in the course of the three steps of the method according to the invention:
An initial phase G₁₁, illustrated by FIG. 3B, made up of static pointing, of short duration, of the pointing tool close to a selectable graphical element EGi centered on the coordinate point C(xi, yi). More precisely, it is considered that the point of initial contact has the coordinates P(x0, y0). At the conclusion of this initial phase, the processing method according to the invention selects the graphical element EGi. This is conveyed from a graphical point of view by highlighting of the selected graphical element. By way of example, this selection is rendered visible by the superimposition of a colored frame on this element on the graphical representation. According to one variant, the representation of the element EGi is enlarged;
An adjustment phase G₁₂, illustrated by FIG. 3C, in the course of which the gesture continues along a rectilinear trajectory along the vertical axis and in the top-to-bottom direction. Advantageously, this axis corresponds to the length of the screen, which allows a broader gesture to be accomplished. This phase of the gesture can be either slow or rapid, the speed of execution not being taken into account in the analysis of the gesture by the method according to the invention. The processing method according to the invention thus involves measuring the distance covered by the pointing tool in the course of a gesture and up to a final point PF(xF, yF), translating this distance covered into a number k of selectable graphical elements EGS covered according to the predetermined coverage order of the sequence and moving the selection of the number k of elements that is obtained. The new highlighted element is the element EGi+k;
A final phase G₁₃, illustrated by FIG. 3D, in the course of which, after having marked a curve at the level of the final point PF, the gesture sets off again in another direction, distinct from the previous one, for example to the right, covering a certain distance again. The processing method according to the invention measures the orientation on and the direction dir of the gesture using a geometric and differential approach, for example by measuring an increase difference in relation to X and to Y that is accumulated over a certain number of points on the trajectory of the gesture—each increase corresponding to the projection of the instantaneous relative movement vector on one of the two axes—and, when the orientation and the direction that are measured coincide with the predetermined second axis and second direction, for example horizontally and to the right, interprets it as a validation command linked to the last graphical element selected.

With reference to FIG. 3E, the validation command associated with the graphical element EGᵢ₊ₖ comprises the checking of a box.

With reference to FIG. 3F, the phases G11, G12 and G13 of the compound gesture G1 are mapped to steps T1, T2 and T3 of the processing method according to the invention.

With reference to FIGS. 4A to 4G, there will now be presented an example of application of the method for processing a compound gesture G₂ according to the invention to the navigation in a system of interlinked menus, within a first graphical interface, of mobile terminal type.

According to a graphical representation of this kind, a menu comprises a sequence of selectable graphical elements, for example arranged vertically in a column. In this example, the main menu shown with reference to FIGS. 4A, 4B and 4C is composed of the graphical elements A to H. It is considered that the first element A has been preselected by default, which corresponds to step T0 in the method according to the invention. It is therefore framed in FIG. 4A. Some graphical elements in the column contain a submenu, such as the element B, for example, that is to say that when they are selected, an ordered subsequence of selectable graphical elements, for example arranged in a column, is accessed. In particular, the element B contains a submenu comprising elements B₁ to B₅. Other elements of the main menu are terminal graphical elements, that is to say that they are associated with direct validation commands, such as a check box or an application to be launched.

With reference to FIG. 4A, the user commences his composition of gestures G₂ by means of approximate pointing G₂₁ to the element G. In this example, the user marks his pointing by means of a short tap, of around 500 ms, close to the element G, which is interpreted in T1 by the processing method according to the invention, according to the absolute-positioning mode of graphical interaction in the coordinate system of the screen, as initial selection of the element G. With reference to FIG. 4B, the selection frame is therefore moved from the element A (preselected by default) to the element G.

Following this initial selection, the mode of interaction considered for the rest of the compound gesture is the relative-positioning mode of interaction along an axis and associated with the sequential logic.

With reference to FIG. 4B, the user executes a second gesture G₂₂ corresponding to a vertical linear trajectory from bottom to top, and therefore in the direction of the element A. It will be noted that, in this example, the gesture does not begin at the level of the element G. It will be recalled that the user has raised his pointing tool between the first gesture and the second. This is not important, however, because in the mode of sequential interaction the absolute positioning of the pointing tool on the touchpad is not taken into consideration.

Of course, with the invention, the user would also have been able to continue the gesture that he had initiated in order to select the element G without raising his pointing tool.

What the method according to the invention detects, in T2, is the direction of the trajectory of this second gesture portion and the distance d covered on the touchpad. On the fly, the number k of selectable graphical elements overflown is determined using the previous equation (1).

In the course of the execution of this second gesture G₂₂, the initial selection, shown in the form of a frame, is therefore adjusted from the element G to the element E, as illustrated by FIG. 4C.

In the course of the execution of a third gesture phase G₂₃, the gesture continues on a second linear trajectory, in the same direction and the same sense as the previous one, which has the effect of adjusting the selection from the element E to the element B, with reference to FIG. 4D.

In this example, the user stops his linear gesture when the selection is placed on the element B.

The user then begins the third phase of his composition, which involves horizontal linear movement to the right, as illustrated by FIG. 4E. It will be noted, here again, that in this example this fourth gesture G₂₄ is detached from the third, since it is at the height of the element G, whereas the third gesture phase G₂₃ ended at the height of the element B. The user has had to raise his pointing tool between the two successive gesture phases. Once again, this is of no importance with the sequential mode of interaction.

Of course, with the invention, the user would also have been able to continue his gesture at the level of the element B, without raising his pointing tool, producing a single compound gesture.

On detection of a change of direction, the processing method according to the invention decides at T3 that the last selected graphical element, namely the element B, is validated and it triggers an associated validation command. As the element B contains a submenu, the validation command is a command for displaying the submenu in question. This submenu is illustrated by FIG. 4F. It comprises five graphical elements B₁ to B₅. The element B₁ is preselected by default, and thus framed. The gestural composition G₂ made by the user has therefore allowed the submenu B to be opened.

With reference to FIG. 4G, the successive phases (or gestures) of the composition G₂ are mapped to steps T1 to T3 of the processing method according to the invention. In this example, the steps of the processing method are implemented in the following sequence: T1 for the gesture G₂₁, T2 for the gesture G₂₂, T2 again for the gesture G₂₃ and T3 for the gesture G₂₄.

With reference to FIGS. 5A to 5G, there is now presented a second example of application of the method for processing a compound touch gesture G₃ according to the invention to the navigation in a system of interlinked menus. In this case, the difference relates to the production of the gesture G3 made continuously in a single multidirectional stroke.

The same graphical representation is considered as in the previous example.

With reference to FIG. 5A, the element A constitutes the default preselection.

In this example, the user commences his gesture by means of approximate pointing G³¹ close to the element D, which is selected by the method according to the invention in the course of a step T1, as illustrated by FIG. 5B.

Without raising the pointing tool, the user continues his gesture with a second vertical linear gesture portion G₃₂ from top to bottom. The distance covered leads, in T2, to the adjustment of the selection to the graphical element E, as shown by FIG. 5C.

Once the selection has been adjusted to the element E, the user continues his gesture with a third portion G₃₃ that forks off 90 degrees to the right. This linear portion is detected and interpreted in T3 as coinciding with the predetermined second orientation and second direction, the effect of which is to trigger validation of the selection of the element E, and therefore to display the submenu that it contains (FIG. 5D). The element E1 of the submenu is then preselected by default.

The user continues his gesture, with a portion G₃₄, taking the form of a vertical movement toward the bottom, which leads to movement of the default selection from the element E₁ to the element E₄ (FIG. 5E). The user finishes his gesture with a horizontal linear portion G₃₅ to the right, interpreted in T3 as validation of the selection of the element E₄.

In this example, the element E₄ is a checkbox. The compound gesture G₃₁-G₃₂-G₃₃-G₃₄-G₃₅ that the user has executed in one go, without raising his pointing tool, has allowed him to check the box of the element E₄ (FIG. 5F).

With reference to FIG. 5G, the successive portions or phases of the gesture G₃ are mapped to steps T1 to T3 of the processing method according to the invention. In this example, the steps of the processing method are implemented in the following sequence: T1 for the gesture portion G₃₁, T2 for the gesture portion G₃₂, T3 for the gesture portion G₃₃, T2 for the gesture portion G₃₄ and T3 for the gesture portion G₃₅.

With reference to FIG. 6, there is now presented the simplified structure of a device for processing a touch gesture according to an embodiment of the invention.

The processing device 100 implements the processing method according to the invention as described above.

In this example, the device 100 is integrated in a piece of terminal equipment ET, comprising a touchpad DT superimposed on a reproduction screen SC.

By way of example, the device 100 comprises a processing unit 110, equipped with a processor P1, for example, and controlled by a computer program Pg₁ 120, which is stored in a memory 130 and implements the processing method according to the invention.

Upon initialization, the code instructions of the computer program Pg₁ 120 are loaded into a RAM memory, for example, before being executed by the processor of the processing unit 110. The processor of the processing unit 110 implements the steps of the processing method described previously, according to the instructions of the computer program 120. According to one embodiment of the invention, the device 100 comprises at least one unit SELECT for selecting a graphical element displayed on the screen, a unit ADJUST for adjusting the selection on the graphical element according to said ordered sequence—on detection of a movement of the pointing tool in a determined direction, the number of graphical elements covered in the sequence being proportional to a distance covered by the pointing tool on the touchpad, a unit for validating the adjusted selection, on detection of a change of direction of the pointing tool, comprising the triggering of a validation command associated with the last selected graphical element.

The unit SELECT comprises, according to the invention, a subunit for toggling the mode of sequential interaction to the mode of graphical interaction, a subunit for selecting a graphical element and a subunit for toggling the mode of graphical interaction to the mode of sequential interaction.

These units are controlled by the processor P1 of the processing unit 110.

The processing device 100 is therefore designed to cooperate with the terminal equipment ET and, in particular, the following modules of this terminal: a module INT_{T} for processing the touch interactions of the user, a module ORDER for ordering an action associated with a graphical element of the representation RG, a module DISP for reproducing a graphical representation RG and a module SOUND for emitting an audible signal. According to one embodiment of the invention, the device 100 moreover comprises a unit INIT for initializing a default preselection, a module MOD for modifying the graphical representation on the basis of the distance covered by the gesture and a module NOT for notifying the user when a selection has been initialized, adjusted or validated. The module NOT is capable of transmitting a vibratory, visual or audible notification message to the relevant interaction modules of the terminal equipment, namely a vibrator module VIBR, the module DISP or a microphone SOUND.

The invention that has just been presented can be applied to any type of sensitive interface connected to a piece of user terminal equipment, provided that the latter displays, on the very interaction surface or else on a remote screen, a graphical representation of an ordered sequence of selectable graphical elements. It facilitates navigation in such a representation, for any type of user, whether sighted, partially sighted or in an “eye-free” situation.

Although the present disclosure has been described with reference to one or more examples, workers skilled in the art will recognize that changes may be made in form and detail without departing from the scope of the disclosure and/or the appended claims.

1. A method for processing a compound gesture, made by a user using a pointing tool on a sensitive pad for a piece of terminal equipment, said equipment moreover having a screen that is capable of reproducing a graphical representation of at least part of an ordered sequence of selectable graphical elements and a module for processing an interaction with the sensitive pad that is capable of interpreting said interaction according to a mode of interaction belonging to a group comprising at least one relative-positioning mode of sequential interaction and an absolute-positioning mode of graphical interaction, wherein said method comprises a selection step that is implemented during execution of the gesture by the user, said selection step comprising the following substeps:
on detection by the equipment of static pointing to a spatial position on the sensitive pad during a predetermined period of time, toggling the mode of interaction to the absolute-positioning mode of graphical interaction, and, when said pointing position is situated at a distance below a predetermined threshold from a graphical element displayed on the screen,
selection of said graphical element,
then toggling the mode of interaction to the relative-positioning mode of sequential interaction, without the pointing tool being raised.

2. The method for processing a compound gesture according to claim 1, wherein the method moreover comprises the following step:
on detection of movement of the pointing tool in a first predetermined orientation, adjustment of the selection to a subsequent or preceding graphical element, in a first direction of the movement, in said ordered sequence, the number of graphical elements covered in the sequence being proportional to the movement of the pointing tool on the sensitive pad and independent of the spatial arrangements of the graphical elements.

3. The method for processing a compound gesture according to claim 1, wherein the method comprises the following step:
on detection of movement of the pointing tool in a predetermined second orientation and second direction, validation of the selection, comprising triggering of a validation command associated with the last selected graphical element.

4. The method for processing a gesture according to claim 1, wherein, prior to the selection step, the equipment preselects a selectable graphical element displayed on the screen.

5. The method for processing a gesture according to claim 2, wherein the method comprises a step of modifying the graphical representation reproduced on the screen at least on the basis of the adjustment of the selection.

6. The method for processing a gesture according to claim 3, wherein the validation command belongs to a group consisting of:
the access to a lower level of a hierarchic menu of selectable graphical elements;
the launch of a determined application program;
the validation of an option;
the return to the higher level of a hierarchic menu of selectable graphical elements.

7. The method for processing a gesture according to claim 3, wherein, following the validation of the selection, said validation comprising triggering of a command for accessing a hierarchic submenu of graphical elements, said method comprises repeating at least one of the steps of selection, adjustment and validation, on the basis of the detected interaction.

8. The method for processing a gesture according to claim 1, wherein the method comprises a step of emission of a visual, vibratory or audible notification signal when a selection, an adjustment or a validation has been made.

9. A device for processing a compound gesture, made by a user using a pointing tool on a sensitive pad for a piece of terminal equipment, said equipment moreover having a screen that is capable of reproducing a graphical representation of at least part of an ordered sequence of selectable graphical elements and a module configured for processing an interaction with the sensitive pad that is capable of interpreting said interaction according to a mode of interaction belonging to a group comprising at least one relative-positioning mode of sequential interaction, and an absolute-positioning mode of graphical interaction, wherein said device comprises:
a selection unit, implemented during the execution of the gesture by the user and configured to, on detection of static pointing to a spatial position on the sensitive pad during a predetermined period of time, toggle the mode of interaction to the absolute-positioning mode of graphical interaction, and when said pointing position is situated at a distance below a predetermined threshold from a graphical element displayed on the screen, select said graphical element, then toggle the mode of interaction to the relative-positioning mode of sequential interaction, without the pointing tool being raised.

10. Terminal equipment of a user, comprising:
a sensitive pad;
a reproduction screen configured to reproduce a graphical representation of at least part of an ordered sequence of selectable graphical elements; and
a device a device configured to process a compound gesture by the user on said pad using a pointing tool, wherein the device is configured to interpret said interaction according to a mode of interaction belonging to a group comprising at least one relative-positioning mode of sequential interaction, and an absolute-positioning mode of graphical interaction, and wherein said device comprises:
a selection unit, implemented during the execution of the gesture by the user and configured to, on detection of static pointing to a spatial position on the sensitive pad during a predetermined period of time, toggle the mode of interaction to the absolute-positioning mode of graphical interaction, and when said pointing position is situated at a distance below a predetermined threshold from a graphical element displayed on the screen, select said graphical element, then toggle the mode of interaction to the relative-positioning mode of sequential interaction, without the pointing tool being raised.

11. (canceled)

12. A non-transitory recording medium that can be read by a processor, on which a computer program is recorded, the program comprising instructions that when executed by a processor configure the processor to execute a method of processing a compound gesture, made by a user using a pointing tool on a sensitive pad for a piece of terminal equipment, said equipment moreover having a screen that is capable of reproducing a graphical representation of at least part of an ordered sequence of selectable graphical elements and a module for processing an interaction with the sensitive pad that is capable of interpreting said interaction according to a mode of interaction belonging to a group comprising at least one relative-positioning mode of sequential interaction and an absolute-positioning mode of graphical interaction, wherein said method comprises a selection step that is implemented during execution of the gesture by the user, said selection step comprising the following substeps:
on detection by the equipment of static pointing to a spatial position on the sensitive pad during a predetermined period of time, toggling the mode of interaction to the absolute-positioning mode of graphical interaction, and, when said pointing position is situated at a distance below a predetermined threshold from a graphical element displayed on the screen,
selection of said graphical element,
then toggling the mode of interaction to the relative-positioning mode of sequential interaction, without the pointing tool being raised.
